(19) United States
(12) Patent Application Publication
(10) Pub. No.: US 2023/0024512 A1
(43) Pub. Date: Jan. 26, 2023

(54) FUNCTIONAL CARBON MATERIALS AND METHODS OF MAKING THE SAME

(71) Applicant: The University of Southern Mississipi, Hattiesburg, MS (US)

(72) Inventors: Zhe Qiang, Hattiesburg, MS (US); Mark Robertson, Hattiesburg, MS (US); Paul Smith, Hattiesburg, MS (US)

(73) Assignee: The University of Southern Mississipi, Hattiesburg, MS (US)

(21) Appl. No.: 17/848,342

(22) Filed: Jun. 23, 2022

Related U.S. Application Data
(60) Provisional application No. 63/311,804, filed on Feb. 18, 2022.
(60) Provisional application No. 63/214,145, filed on Jun. 23, 2021.

(51) Int. Cl. C08J 3/24; B33Y 80/00; C08J 9/00

(52) U.S. Cl. CPC C08J 3/24; B33Y 80/00; C08J 9/0085

(57) ABSTRACT

Carbon materials formed using various templates of precursor materials are described in addition to method and process for producing the same.

### CROSS-REFERENCE TO RELATED APPLICATION

This application claims priority to U.S. Provisional Application No. 63/214,145 to Zhe Qiang et al. filed on Jun. 23, 2021, and to U.S. Provisional Application No. 63/311,804 to Zhe Qiang et al. filed on Feb. 18, 2022, the contents of which are incorporated herein by reference in their entirety.

### FIELD

The present subject matter generally relates to functional carbon materials, namely a sulfonated and carbonized carbon material, and a method of making the same.

### BACKGROUND

Porous carbon has been used across many applications such as water purification, CO₂ capture, supercapacitors and battery technologies. Generally, increasing the specific surface area and pore volume of porous carbons make them more effective in their applications. For instance, increased pore volume and surface area allows for CO₂ to interact with more sites within a porous carbon matrix, resulting in greater amounts of CO₂ being captured by the carbon sorbents, and more efficiently scrubbing commercial production process streams. Highly porous carbon with large pore volumes has been synthesized through a variety of techniques with varied starting materials. These processes typically involve costly processing steps or starting materials that are expensive, making these materials difficult to produce at a commercially-relevant scale. Additionally, methods of enhancing the pore characteristics, such as activation, typically involve harsh chemicals and additional processing steps.

Current methods for synthesizing porous carbon materials for CO₂ capture often involve complex or specialized starting materials, such as metal-organic frameworks or activation procedures that can involve many steps and harsh chemicals like potassium hydroxide (KOH). While it has been shown previously that sulfonating polymers, such as polyethylene, through exposure to sulfuric acid can allow these materials to be converted to carbons, such carbon materials are only produced with a two-step sulfonation treatment.

Moreover, carbon materials are important and commonly used across a variety of high-performance industries, including the automobile, additive manufacturing (e.g., 3D printing), and aerospace industries. Their ability to provide durability while being lightweight makes carbon composites potential alternatives to heavier metal counterparts. Currently, carbon fibers are mostly made from relatively expensive precursors (polyacrylonitrile) and require multiple energy-intensive steps for fabrication, hindering the ability to produce low-cost carbon fibers.

### BRIEF DESCRIPTION

According to some aspects of the present disclosure, a structure includes one or more carbonized materials. Each carbonized material has been crosslinked and has a shape based on a polymer based template structure.

According to some aspects of the present disclosure, a structure includes one or more carbonized materials each formed of a chemical compound having a structure disclosed herein. Each carbonized material has a pore structure comprising an average surface area greater than about 200 m²/g and an average pore volume of less than about 1 cm³/g.

These and other features, aspects, and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 illustrates a scheme that outlines the processing steps for the development of highly porous carbon materials using mask as templates.

FIG. 2 is a graphical representation of preliminary data of nitrogen adsorption isotherms of carbonized materials as a function of resol-content present in a solution used for coating an initial structure template.

FIG. 3 depicts SEM micrographs of pristine surgical mask fibers and mask fibrous structures after sulfonation and carbonization using a method disclosed herein.

FIG. 4A depicts a demonstration of the flexibility of a neat surgical mask.

FIG. 4B depicts a demonstration of the flexibility of a deformed carbonized surgical mask.

FIG. 4C depicts a demonstration of the flexibility of a carbonized surgical mask after deformation illustrating the retention of the shape of the carbonized surgical mask.

FIG. 5 is a graphical representation of results of a thermogravimetric analysis (TGA) (under N₂ atmosphere) for sulfonated masks after exposure for 0 hours, 4 hours, 6 hours, and 10 hours.

FIG. 6 is a graphical representation of mass gain of an initial structure formed of polypropylene (PP) masks as a function of sulfonation reaction time at 155° C.

FIG. 7 is a graphical representation of an FTIR spectra of sulfonated structures at various reaction times where peaks are highlighted to monitor reaction progression.

FIG. 8 is a schematic depiction of conversion of an initial polymer to a sulfonated carbonized material via a crosslinking mechanism of polypropylene that is initiated through a sulfonation step which is followed by olefination and subsequent addition/rearrangement.

FIG. 9A illustrates a fibrous structure of an initial structure prior to sulfonation.

FIG. 9B illustrates a fibrous structure of an initial structure after 2 hours of sulfonation.

FIG. 9C illustrates a fibrous structure of an initial structure after 12 hours of sulfonation.

FIG. 10 is a graphical representation of TGA thermograms of pristine PP initial structures and sulfonated PP structures (from masks) after different crosslinking times.

FIG. 11 illustrates an SEM image of carbonized fibers after 2 hours of sulfonation, leading to the decomposition of the unreacted center portions of the fiber. The inset image depicts a hollow fiber which results from insufficient crosslinking.

FIG. 12 illustrates an SEM image of carbonized fibers after 12 hours of sulfonation which results in complete crosslinking, and continuous fibers.

FIG. 13 is a graphical representation of EDAX mapping of carbon element of carbonized fibers after 12 hours of sulfonation.

FIG. 14 is a graphical representation of EDAX mapping of sulfur element of carbonized fibers after 12 hours of sulfonation.

FIG. 15 is a graphical representation of an XPS spectrum of carbonized fibers after 12 hours of sulfonation.

FIG. 16 is a graphical representation of Raman spectroscopy employed to characterize the degree of graphitization of carbonized fibers.

FIG. 17 is a graphical representation of nitrogen adsorption-desorption isotherm of carbonized fibers.

FIG. 18 is a graphical representation of hysteresis that occurs at the partial pressure range from 0.6 to about 1.0 for carbonized fibers.

FIG. 19 is a graphical representation of associated pore size distribution determined using the Barrett, Joyner and Halenda (BJH) model.

FIG. 20 is a graphical representation of temperature of a carbonized material as a function of voltage.

FIG. 21A illustrates a water angle measured from carbonized materials.

FIG. 21B illustrates a water angle measured from carbonized materials exposed to chloroform.

FIG. 22 is a graphical representation of oil uptake capacity of the carbonized mask fibers given as gram of sorbate per gram of sorbent.

FIG. 23 is a graphical representation of cycling performance of the oil adsorption performed by adsorbing chloroform, heating to remove the sorbate, and repeating this process for 5 cycles.

FIG. 24 is a graphical representation of N₂ adsorption isotherm of carbonized mask fibers after the activation process.

FIG. 25 is a graphical representation of dye adsorption study at a concentration of 0.15 mg/mL investigating the adsorption capacities as a function of time of activated carbon fibers compared to powder activated carbon (PAC).

FIG. 26 is a graphical representation of FTIR spectra of crosslinked polypropylene fibers with increasing sulfonation time.

FIG. 27 is a graphical representation of an XPS survey scan of crosslinked polypropylene fibers with increasing sulfonation time.

FIG. 28 is a graphical representation of a carbon yield of crosslinked polypropylene fibers with increasing crosslinking time.

FIG. 29A is a graphical representation of N₂ adsorption isotherm of carbonized mask fibers after 2 hours of crosslinking time.

FIG. 29B is a graphical representation of N₂ adsorption isotherm of carbonized mask fibers after 4 hours of crosslinking time.

FIG. 29C is a graphical representation of N₂ adsorption isotherm of carbonized mask fibers after 6 hours of crosslinking time.

FIG. 30 is a graphical representation of XPS survey scan spectra and heteroatom content of oxygen and sulfur in carbonized fibers with varying crosslinking times.

FIG. 31A is a graphical representation of high resolution XPS spectra and fitting results of carbon of carbon fiber masks, initially crosslinked for 6 hours.

FIG. 31B is a graphical representation of high resolution XPS spectra and fitting results of oxygen of carbon fiber masks, initially crosslinked for 6 hours.

FIG. 31C is a graphical representation of high resolution XPS spectra and fitting results of sulfur of carbon fiber masks, initially crosslinked for 6 hours.

FIG. 32 is a graphical representation of a CO₂ adsorption isotherm at room temperature of carbonized mask fibers, which were crosslinked after varying time.

Repeat use of reference characters in the present specification and drawings is intended to represent the same or analogous features or elements of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

The generation of porous carbon materials can be crucial in a wide range of applications, including batteries, pollutant removal from water sources, catalyst support and CO₂ capture from commercial processes. Disclosed herein are carbon materials formed using a polypropylene surgical mask as a template and applying a combination of crosslinking and carbonization steps to result in porous carbon fibers.

Each method involves using an initial structure formed of precursor material(s) as a template to fabricate resulting, multi-functional carbon materials. The precursor material may be any material having a polyolefin backbone, including but not limited to homopolymers, blended materials, and copolymers. For example, the precursor material(s) may be any one or more of the following: polypropylene (PP), PE, or thermoplastic elastomers (e.g., nanostructured thermoplastic elastomer containing crosslinked polyolefins, polystyrene-block-poly(ethylene-ran-butylene)-block-polystyrene (SEBS), polystyrene-block-polyisoprene-block-polystyrene (SIS), and polystyrene-block-polybutadiene-block-polystyrene (SBS), etc.). The precursor material(s) may include fiber filler or may be free of fiber filler. The initial material or template structure is one of a 3D printed structure, a fiber, a porous scaffold, an injection molded structure, an extruded structure, or a compression molded structure. In various examples, the initial material may be a structured plastic waste, such as polypropylene-based surgical masks or N95 masks. In other examples, the initial material may be a nanostructured thermoplastic elastomer, or structured plastics prepared using fused deposition modeling (FDM) and having a complex 3D shape, such as a gyroid-shape object. In some instances, the printed precursor material may be printed from polypropylene-carbon nanofiber filaments. Using FDM printed shapes allows production of nearly zero-shrinkage, lightweight carbon structures having highly tailorable geometry.

Efficient transformation of polyolefins precursors, such as the precursor materials discussed above, into carbonaceous products, such as the porous carbons disclosed herein, requires thermally stabilizing the polyolefin chains through crosslinking prior to carbonization. Accordingly, each of the methods disclosed herein includes a combination of sulfonation, cross-linking, and carbonization steps to fabricate resulting, multi-functional carbon materials.

In a first method for generating porous carbons having surface areas of about 500 m²/g to about 2500 m²/g and pore volumes of about 5 cm³/g to about 45 cm³/g, the initial structure used is a structured plastic wastes (e.g. nonwoven polypropylene mats) including fibers exhibiting controlled pore sizes and formed of a precursor material such as, for example, polypropylene. This method utilizes stabilization via cross-linking combined with carbonization to convert a coating applied to the precursor materials of the initial structure into porous carbon materials. Specifically, a commercially-available phenolic resin coating, resol, is applied to the initial structure to coat the fibers by submerging the initial structure into a precursor-containing solution, such as a resol-ethanol solution for about 2 minutes. The solvent is then allowed to evaporate from the initial structure, leaving a resol-coated initial structure. The resol-coated initial structure is then cross-linked at about 100° C. to about 150° C. for about 2 hours to about 24 hours and is subsequently carbonized by heating the resol-coated initial structure to a carbonization temperature of about 800° C. at a rate of about 5° C./min. The carbonization temperature is maintained at about 800° C. for about 2 hours.

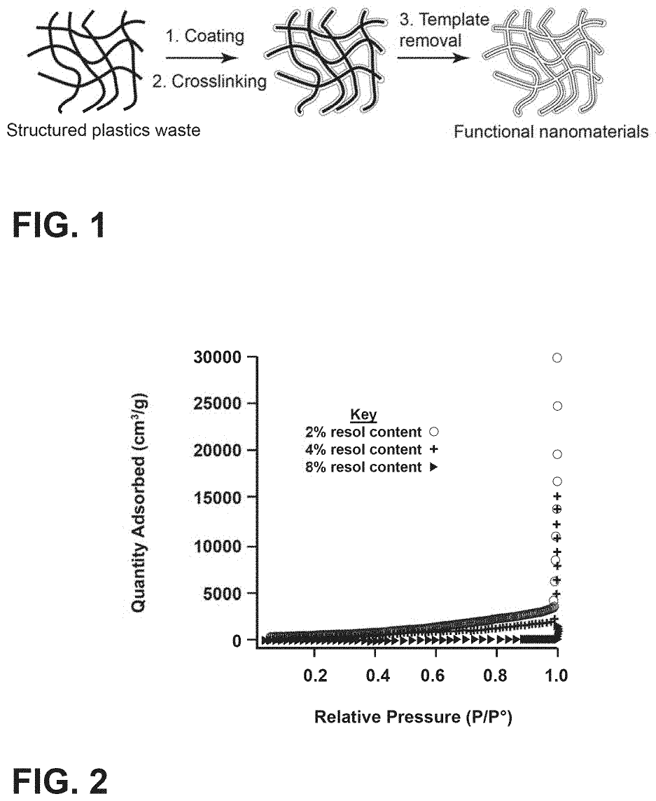

Using structured plastic waste as the initial structure allows the structured plastic waste to act as a template and, when crosslinked and carbonized, the polymers that make up the fibers of the structured plastic waste undergo pyrolysis. As shown in FIG. 1, this transforms the cross-linked resol coated structured plastic waste into hollow fibril materials (also referred to herein as porous carbon fibers) that maintain the original porous structure of the fibers of the structured plastic waste. The hollow fibril materials are formed of the crosslinked resol coating. In various examples, the resulting porous carbon fibers may be functionalized using a doping assembly, an activation process, and/or a co-operative assembly with other polymers and/or inorganic agents. It is contemplated that these porous carbon fibers may be scaled up to large-scale productions. It is further contemplated that the carbonization temperature can be varied to tailor the product to different applications. The porous carbon fibers produced through this technique exhibit a surface area and pore volume that exceeds that of commercially-available porous materials, as discussed in more detail elsewhere herein. Specifically, the carbon fibers or any other carbonized materials produced using this method may have a pore structure having an average surface area of about 500 m²/g to about 2700 m²/g (e.g., about 500 m²/g to about 2500 m²/g, 2500 m²/g to about 2700 m²/g, about 2592 m²/g, etc.) and having an average pore volume of about 5 cm³/g to about 45 cm³/g (e.g., about 40 cm³/g to about 45 cm³/g, about 43 cm³/g, etc.).

The increased surface area and pore volume of the hollow fibril materials may make the resulting hollow fibril materials more efficient in various applications. For instance, increased pore volume and surface area may allow for CO₂ to interact with more sites within a porous carbon matrix, resulting in greater amounts of CO₂ being captured by the fibril materials, and more efficiently scrubbing commercial production process streams. In addition to exhibiting a higher surface area and a higher pore volume as compared to known porous carbons, the resulting porous carbon fibers are produced for a similar cost. Moreover, both the simplicity of the processes and highly affordable starting materials allow the resulting porous carbon fibers to be produced by these methods in amounts that can easily be scaled to larger processes.

In another method, porous carbons are produced through selective sulfonation and thermal stabilization of matrix species in the precursor materials of the initial structure and degradation of uncrosslinked parts of the polymer domains within the material. The crosslinking mechanism of precursor material is initiated through a sulfonation step which is followed by olefination and subsequent addition/rearrangement. Polyolefin based chains can then crosslink, followed by ring closure and degradation of functional groups at elevated temperatures. This process is shown in FIG. 8, which shows the process of taking a material having a polyolefin backbone and converting the material to a carbonized material having the chemical structure shown in FIG. 8 after carbonization.

The initial structure is generally prepared based on the specific precursor materials included. For example, the initial structure may be thermally stabilized (e.g., through thermal annealing) to prevent deconstruction of the defined structures of the initial structure. The initial structures may further be resized or reshaped (e.g., through trimming), printed, or otherwise prepared.

After the initial structure is prepared, the precursor materials of the prepared initial structure may be crosslinked. Crosslinking the precursor materials may include using a nonvolatile solvent (e.g., concentrated sulfuric acid) to selectively crosslink chemical species of the precursor material, allowing for specific constituents to degrade upon carbonization and the generation of pores.

In some examples, crosslinking may be achieved in conjunction with sulfonation of the prepared initial structure. The prepared initial structure may be submerged in a neat sulfuric acid solution at an elevated sulfonation temperature for one or more extended periods of time and at atmospheric pressures. It is contemplated that other solutions may be used for sulfonation, including fuming acid and diluted sulfuric acid, without departing from the scope of the present disclosure. The elevated sulfonation temperature ranges from about 100° C. to about 200° C. For example, the elevated sulfonation temperature may be about 140° C., about 150° C., about 155° C., about 160° C., about 165° C., about 170° C., about 175° C., about 180° C., about 185° C., about 190° C., about 195° C., about 200° C. or any value or range of values therebetween. The period of time for which the initial structure may be submerged may be about 2 hours, about 6 hours, or about 12 hours. However, it is contemplated that the sulfonation time may range from about 15 minutes to about 72 hours without departing from the scope of the present disclosure. This submersion in the neat sulfuric acid sulfonates the initial structure. After or during sulfonation, the initial structure is stabilized through crosslinking. For example, where the initial structure is a PP-based mask, the sulfonation effectively crosslinks the polypropylene fibers prior to carbonization.

In other examples, the prepared initial structure may be sulfonated at an elevated sulfonation temperature for one or more extended periods of time and at atmospheric pressures. The sulfonated initial structure may then be de-sulfonated. De-sulfonation may include heating in the initial structure to a predetermined de-sulfonation temperature for a period of time. For example, the initial structure may be heated to about 120° C. for about one hour. De-sulfonation eliminates sulfur, oxygen, and hydrogen to yield unsaturated polyolefin, providing the reaction sites for effectively crosslinking the matrix. In various examples, the crosslinked and/or sulfonated structure may be rinsed with water prior to carbonization.

To briefly describe the thermal stabilization mechanism, the initial sulfonation reaction of polypropylene proceeds by reacting with the secondary/tertiary carbons along the polymer backbone, followed by the homolytic dissociations of sulfonyl groups, which results in unsaturated bonds within the polymer chain. These double bonds from sulfonation continue to react through a secondary addition, rearrangement, and dissociation, leading to formation of radical species that directly couple with other reactive groups from surrounding polymer chains, effectively producing crosslinked network structures. These crosslinked polymers can then be converted to carbons upon pyrolysis, potentially stripping away functional groups upon exposure to elevated temperatures in inert atmospheres.

In various examples, the sulfonation-crosslinking step may also impart additional functionality into the carbon fibers, such as inherent incorporation of sulfur heteroatoms into the carbon framework. Sulfur doping of the carbonized materials can enhance the functionality of associated carbon-based materials in many applications, including energy storage, catalysis, and CO₂ adsorption.

The crosslinked and/or sulfonated structure (e.g., a sulfonated polyolefin) is then converted to carbonaceous materials (e.g., porous carbons) using carbonization processes, including without limitation, pyrolysis under N₂. In various examples, the crosslinked and/or sulfonated structure is carbonized by heating the sulfonated structure from an initial temperature to a carbonization temperature at a predetermined rate. The initial temperature may be about 25° C., and the carbonization temperature may be any temperature or temperature range of about 800° C. to about 1400° C. The predetermined rate may have a range of about 1° C./min to about 10° C./min. For example, the predetermined rate may be 5° C./min. In some examples, various rates may be used to reach one or more temperatures during carbonization (e.g., heating the crosslinked and/or sulfonated structure to a first temperature at a first rate and then heating the crosslinked and/or sulfonated structure from the first temperature to a second temperature at a second rate). The carbonization temperature may then be maintained for a predetermined holding time. For example, the carbonization temperature may be maintained for about 2 hours. In general, increasing the carbonization temperatures can enhance the degree of graphitization, which improves the electrical and thermal conductivities, as discussed in more detail elsewhere herein.

Throughout this process, the initial fibril structures of the masks can be completely retained, resulting in a carbon fiber mat with mechanical flexibility. In fact, the resulting carbon fibers exhibit retention of the shape of the initial structure, increased flexibility and durability, and a greater than 50% carbon yield from the initial structure. During the carbonization process, gaseous products are released through the decomposition of the fiber, which may induce porosity, as well as enhanced surface areas. For example, the carbonized fiber or other materials may have a pore structure having an average surface area greater than about 200 m²/g and an average pore volume less than about 1 cm³/g. In some examples, the average surface area may be about 250 m²/g to about 700 m²/g.

As described in more detail in Examples 1-11, a suite of characterization techniques has been employed to confirm the microstructures and properties of these resulting porous carbon fibers. Furthermore, these microstructures and properties enable potential use of the porous carbon fibers in several practical applications, including 3D-printing, oil sorbents, nanofillers for imparting electrical conductivity and Joule heating behaviors of composites, water purification, and energy storage. It will be understood that these steps may be applied to any initial structure formed of the precursor materials without departing from the scope of the present disclosure.

### Example 1

In this Example 1, the initial structure was a structure plastic waste, namely common surgical masks formed of nonwoven polypropylene mats. Samples 1.1-1.3 (“S1.1”, “S1.2”, and “S1.3”, respectively) were taken of the mask. Each Sample was submerged into a precursor-containing solution, a resol-ethanol solution, for about 2 minutes. S1.1 was submerged in a solution containing about 2% resol, S1.2 was submerged in a solution containing about 4% resol, and S1.3 was submerged in a solution containing about 8% resol. The solvent was then allowed to evaporate from the Samples, leaving a resol-coated initial structure. The resol-coated initial structure of each Sample was then cross-linked at about 150° C. for about 2 hours. Each Sample was subsequently carbonized by heating the resol-coated initial structure to a carbonization temperature of about 800° C. at a rate of about 5° C./min. The carbonization temperature was maintained at about 800° C. for about 2 hours.

The N₂ adsorption-desorption behavior of the carbonized materials of each Sample was characterized using gas physisorption measurements, which can determine pore volume, pore size distribution, and surface area of the carbon samples. Results of the testing are shown in Table 1 below and can be seen in FIG. 2. Pore size distribution of samples was estimated from the adsorption isotherm using the Barrett, Joyner and Halenda (BJH) model, whereas the surface area was determined from the typical Brunauer Emmett and Teller (BET) analysis.

TABLE 1

| | | Average | Average | Maximum |
|---|---|---|---|---|
| | | Relative | Quantity | Quantity |
| Sample | % | Pressure | Adsorbed | Adsorbed |
| Number | Resol | (P/P0) | (cm³/g) | (cm³/g) |
| S1.1 | 2.0 | 0.667 | 2531.402 | 29727.508 |
| S1.2 | 4.0 | 0.672 | 1799.481 | 15198.359 |
| S1.3 | 8.0 | 0.704 | 344.630 | 1632.561 |

As shown by the data from preliminary nitrogen adsorption experiments illustrated in Table 1 and FIG. 2, the resulting porous carbon fibers produced and tested in this Example 1 provide pore structures with high surface areas (about 2592 m²/g) and large pore volumes (about 43 cm³/g). Compared to the pore volumes of commercially-available activated carbons currently available, which have a pore volume of less than about 1 cm³/g and a surface area of less than about 1000 m²/g, these pore volumes of Samples 1.1-1.3 are nearly forty times as large and the surface areas are nearly three times as large as. Accordingly, these porous carbon fibers would offer better performance than currently available commercially-available activated carbons for adsorption.

### Example 2

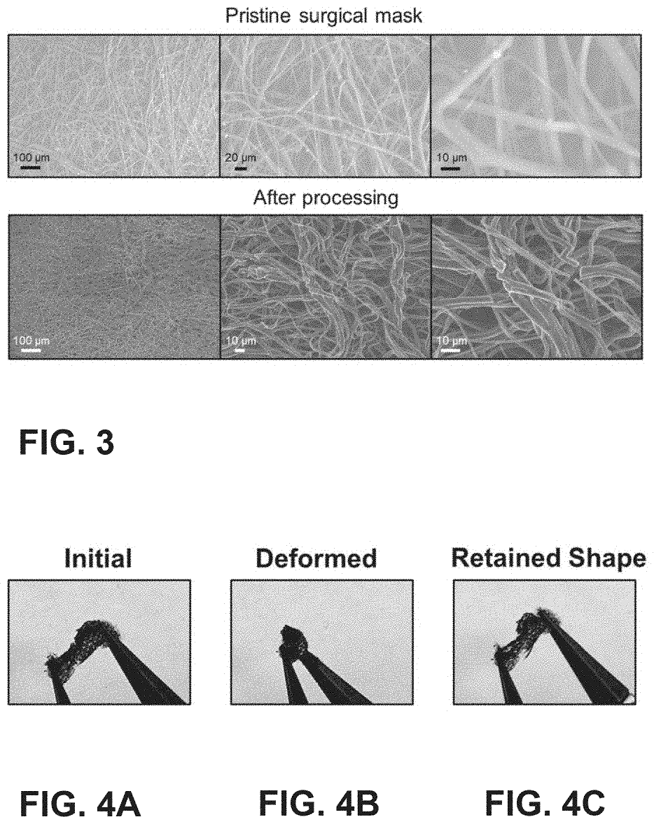

In this Example 2, the initial structure was a structured plastic waste, namely common surgical masks formed of a porous mat of polymer fibers (e.g., melt-blow polypropylene fibers). Each polymer fiber had well-defined fibril microstructures with an average fiber diameter of about 10 nm. These microstructures are shown in FIG. 3, which illustrates SEM micrographs of pristine surgical mask fibers compared with the mask fibrous structures after sulfonation and carbonization.

The initial structure was submerged in a neat sulfuric acid solution at a temperature of about 155° C. for various extended periods of time and at atmospheric pressures. This submersion in the neat sulfuric acid sulfonated the polymer fibers, which were then stabilized through crosslinking. The sulfonated polymer fibers were rinsed with water and carbonized by heating the sulfonated polymer fibers from 25° C. to 800° C. at a rate of 5° C./min. The temperature was maintained at about 800° C. for about 2 hours. In other examples, the sulfonated polymer fibers were carbonized by heating to 1000° C. for 2 hours.

The retention of the initial fibril structures of the polymer fibers of the initial structure after sulfonation is shown by comparison of the SEM images included in FIG. 3. The sulfonated polymer fibers could be continuously deformed and returned to the original position without resulting in irreparable damage to the structure. FIGS. 4A, 4B, and 4C together depict a sequence of photos illustrating this macroscopic flexibility and durability of a surgical mask after sulfonation. Moreover, after carbonization at 1000° C. for about 2 hours, the carbonized surgical masks completely retained their shape before exposure.

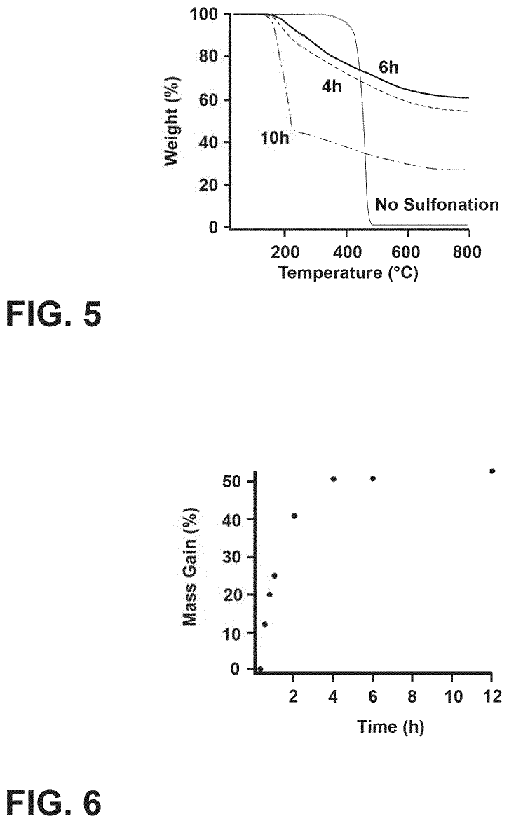

In addition to the increased flexibility and durability, the production of the carbon materials using this method resulted in minimal mass loss. Table 2 sets forth the results of the testing, which are shown in FIG. 5.

TABLE 2

| Sulfonation | Mass Retention |
|---|---|
| Time (hours) | (%) |
| 0 | 0.0 |
| 4 | 30.0 |
| 6 | 57.0 |
| 10 | 65.0 |

Under optimization, sulfonation for about 6 hours lead to about 65% mass retention after carbonization. Accordingly, about 2 grams of the polymer fibers produced about 1.2 grams to about 1.4 grams of the resulting carbon fibers. Generally, increasing the amount of exposure results in higher degrees of carbonization of the polypropylene fibers. At sufficiently long exposure times (about 10 hours), the structures and their performance deteriorated. However, as illustrated by FIG. 5, there was no carbon yield for polymers without the sulfonation step, as polymers with the sulfonation step exhibited 100% mass loss under elevated temperatures in an N₂ atmosphere.

### Example 3

In this Example 3, the initial structure selected was PP-based surgical masks. During the step of preparing the initial structure step, the surgical masks were cut to remove the elastic bands and metal nosepiece. The resulting fabric was separated into three constituent layers, including two layers of non-woven fabrics and a melt-spun mat layer. In this Example, only outer layers were used to form 5 samples of the initial structure (each sample consisting of a section cut to have an average size of about 8 cm by about 5 cm).

To sulfonate the samples of the initial structure, these about 1 gram in total of the mask-formed initial structures were transferred into glass containers containing about 25 ml of concentrated sulfuric acid (98 wt %). In this step, a glass slide was placed on top of the mask-formed initial structures to keep the initial structures completely submerged in the sulfuric acid throughout the reactions. The glass containers were then placed in a muffle furnace and heated to about 155° C. During heating, a temperature ramp of about 1° C./min was used. Heating occurred for various amounts of time.

Upon sulfonation, the samples of the initial structure were removed from the muffle furnace and cooled down to room temperature. To wash the samples, sulfuric acid was first removed from the glass containers. Subsequently, the samples were carefully placed in a quartz funnel, where each sample was washed at least three times with deionized water in order to completely remove the residue acid. The neuralization was confirmed by pH papers. The samples were then dried by placing on a glass petri dish in a vacuum oven for overnight.

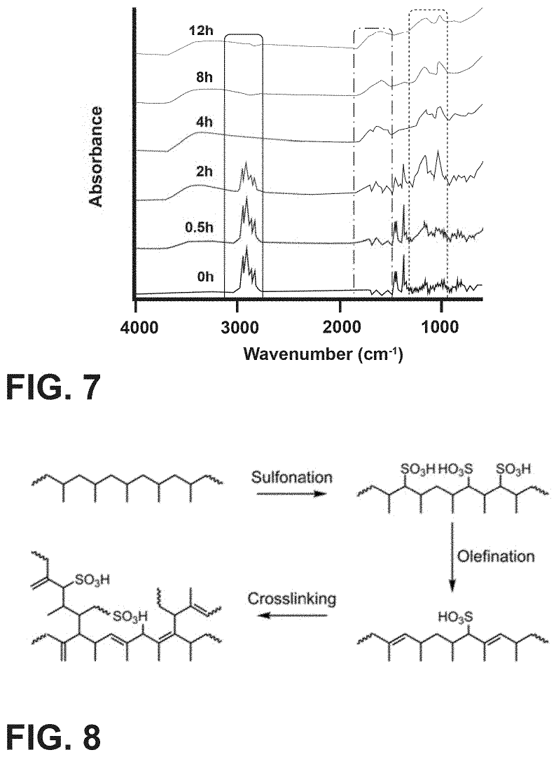

A PerkinElmer Frontier Attenuated Total Reflection (ATR) Fourier-transform infrared (FTIR) spectrometer was used to record the changes in chemical compositions of the sulfonated samples as a function of time. The scan range was 4000 cm¹-600 cm⁻¹ with 32 scans and a resolution of 4 cm′. The progress of the sulfonation reaction was monitored by tracking mass gain as a function of sulfonation time, as well as through FTIR spectroscopy. Results of these monitoring methods are illustrated in FIGS. 6 and 7.

As shown in FIG. 6, at short time scales, the PP mass gain as a function of time increased rapidly as the sulfonation reaction progresses. After about 4 hours, the mass gain reached a plateau value of about 51%. This plateau value remained nearly constant (i.e., at about 52%) even after extending the reaction time to about 12 hours. As shown in FIG. 7, FTIR spectra also confirmed that sulfonation reaction results in the formation of double bonds and sulfonic acid groups in PP. Specifically, pristine PP fibers from masks exhibited peaks indicative of C—H stretching at about 2920 cm⁻¹ which diminished as the sulfonation/crosslinking reaction progressed and completely disappeared after about 4 hours of reaction time. Additionally, the appearance of three separate peaks can be attributed to the progress of reaction. The broad —OH stretching peak at about 3300 cm⁻¹ emerged after about 30 min, and its peak intensity increased with increasing reaction time. Peaks from about 1250 cm⁻¹ to about 1000 cm⁻¹ can be attributed to the presence of sulfonic acid groups. The addition of alkenes into the PP backbone were demonstrated by the emerging peaks at about 1600 cm⁻¹. Although the samples did not gain further mass after about 4 hours of reaction time, the FTIR traces suggest that the reaction continued to progress until about the 12 hour mark.

### Example 4

In this Example 4, the samples from Example 3 were analyzed to determine the morphological changes of the fiber structure after various sulfonation time periods using a Zeiss Ultra 60 field emission scanning electron microscope (SEM). Specifically, the fiber structures of the initial samples of Example 3 and the sulfonated samples of Example 3 (including samples sulfonated for about 2 hours and for about 12 hours) were further investigated using SEM. During these measurements, energy dispersive X-ray spectroscopy (EDS) was coupled for determining the content of different elements within the materials after sulfonation. Additionally, fiber diameters were determined and recorded using ImageJ image analysis software. X-ray photoelectron spectroscopy (XPS) experiments were performed using a Thermo-Fisher ESCALAB Xi+ spectrometer equipped with a monochromatic Al X-ray source (1486.6 eV) and a MAGCIS Ar+/Arn+gas cluster ion sputter (GCIS) gun. Measurements were performed using the standard magnetic lens mode and charge compensation. The base pressure in the analysis chamber during spectral acquisition was at 3×10-7 mBar. Spectra were collected at a takeoff angle of 90° from the plane of the surface. The pass energy of the analyzer was set at 150 eV for survey scans with an energy resolution of 1.0 eV; total acquisition time was 220 s. Binding energies were calibrated with respect to C is at 284.8 eV.

As shown in FIG. 8, the outer layers of the masks used to create the samples of the initial structure were composed of PP fibers with a relatively uniform diameter of about 25 μm (25.7±0.7 μm). Even when the initial samples were exposed to a slightly higher crosslinking/sulfonation temperature (about 156° C.), which approaches the onset of melting in the PP fibers, the sulfonated samples fully retained the fibral structures of the initial samples. After about 2 hours, the fiber diameter of the samples undergoing sulfonation slightly changed to about 21 μm (21.6 μm) and remained relatively constant after about 12 hours of sulfonation.

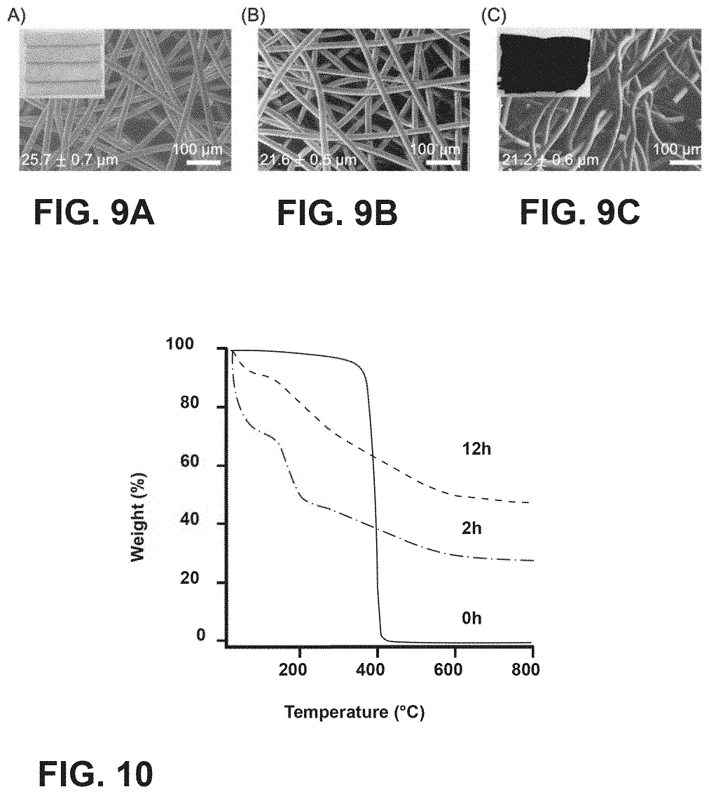

It was also found that extending the reaction time to about 12 hours did not alter the fiber diameters, and yet can result in slight distortion and curving of the fibers, as shown in FIG. 9C. Furthermore, as shown in the insets of FIGS. 9A-9C, the macroscopic structures are retained after each processing step. FIG. 9A demonstrates the neat PP mask and its initial structure prior to sulfonation, while the inset in FIG. 9C shows the form was maintained throughout the sulfonation process.

### Example 5

In this Example 5, carbonization of the sulfonated and thermally stabilized samples from Example 4 was performed using an MTI Corporation OTF-1200X tube furnace under an N₂ atmosphere. The samples were heated at a rate of about 1° C./min until reaching a temperature of about 600° C. The samples were then heated at a rate of about 5° C./min until reaching a carbonization temperature of about 800° C. or higher. The carbonization temperature was maintained for a holding time of about 3 hours.

Samples from Example 4 were evaluated to determine carbon yield after two distinct crosslinking times (about 2 hours of sulfonation and about 12 hours of sulfonation). Carbon yield was determined using Thermogravimetric analysis (TGA) conducted using a Discovery Series TGA 550 (TA Instruments) to determine the mass loss of polymer precursors as a function of pyrolysis temperature. Sulfonated samples, approximately 10-20 mg in mass, along with a control sample of un-sulfonated PP were pyrolyzed under a N₂ environment, replicating the carbonization procedure used in the tube furnace.

All organic components of the control sample were completely degraded with 0% mass retention after exposure to about 800° C. under N₂. As shown in FIG. 10, the sulfonated samples having lower reaction times (i.e., 2 hours) exhibited a higher mass loss upon carbonization. This may be attributed to incomplete crosslinking of PP throughout the entire fiber structure of the samples. Specifically, sulfonated samples undergoing about 2 hours of sulfonation resulted in a carbon yield of about 51%, while sulfonated samples undergoing about 12 hours of sulfonation exhibited a carbon yield of about 58%. Both carbon yields were derived from the sulfonate state of the samples.

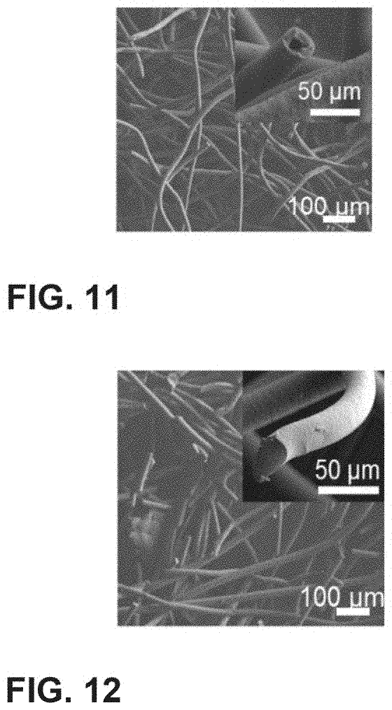

Additionally, the samples undergoing only 2 hours of sulfonation exhibited hollow structure carbon fibers (see FIG. 11) while the samples undergoing 12 hours of sulfonation resulted in carbon fibers with solid cores (see FIG. 12). Additionally, the TGA thermogram of the sulfonated samples undergoing about 12 hours of sulfonation exhibited no secondary thermal decomposition after 100° C. This may be attributed to the decomposition of unreacted polymer chains within the fibers of the samples.

Specifically, the fiber structures of the initial samples of Example 3 and the sulfonated samples of Example 3 (including samples sulfonated for about 2 hours and for about 12 hours) were further investigated using SEM. During these measurements, energy dispersive X-ray spectroscopy (EDX) was coupled for determining the content of different elements within the materials after sulfonation. Additionally, fiber diameters were determined and recorded using ImageJ image analysis software. X-ray photoelectron spectroscopy (XPS) experiments were performed using a Thermo-Fisher ESCALAB Xi+ spectrometer equipped with a monochromatic Al X-ray source (1486.6 eV) and a MAGCIS Ar+/Arn+gas cluster ion sputter (GCIS) gun. Measurements were performed using the standard magnetic lens mode and charge compensation. The base pressure in the analysis chamber during spectral acquisition was at 3×10-7 mBar. Spectra were collected at a takeoff angle of 90° from the plane of the surface. The pass energy of the analyzer was set at 150 eV for survey scans with an energy resolution of 1.0 eV; total acquisition time was 220 s. Binding energies were calibrated with respect to C is at 284.8 eV.

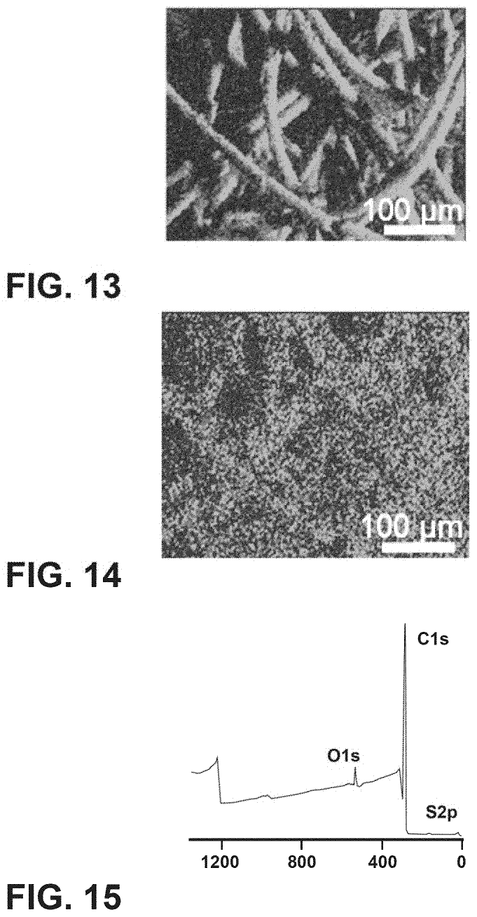

FIGS. 13 and 14 depict the elemental maps that correspond to both carbon and sulfur produced through EDX. The sulfur doping content was found to be about 5.6 wt % for the carbon fibers resulting from carbonized PP masks that underwent about 12 hours of sulfonation. The overlaid elemental map shown in FIGS. 13 and 14 also demonstrates that the heteroatoms are uniformly distributed within the carbon fibers. The presence of heteroatoms in the carbon framework of the mask waste derived carbon fibers was further investigated using x-ray photoelectron spectroscopy (XPS). FIG. 15 depicts the survey scan of the carbonized fibers after 12 hours of sulfonation, indicating the presence of carbon (284.09 eV), oxygen (532.20 eV), and sulfur (163.79 eV) moieties within the framework of the resulting carbon materials at 96.7 atom %, 2.9 atom %, and 0.4 atom %, respectively. The peaks at 163.5 eV and 164.7 eV shown in FIG. 15 suggest that the sulfur atoms are directly bonded to carbon as part of the framework rather than being bonded to oxygen which would be illustrated by the presence of peaks at slightly higher binding energies. When compared to the EDX results, this lower doping content from XPS measurements suggests that the surface of the resulting carbon fibers may have a lower sulfur content than the interior of the resulting carbon fibers.

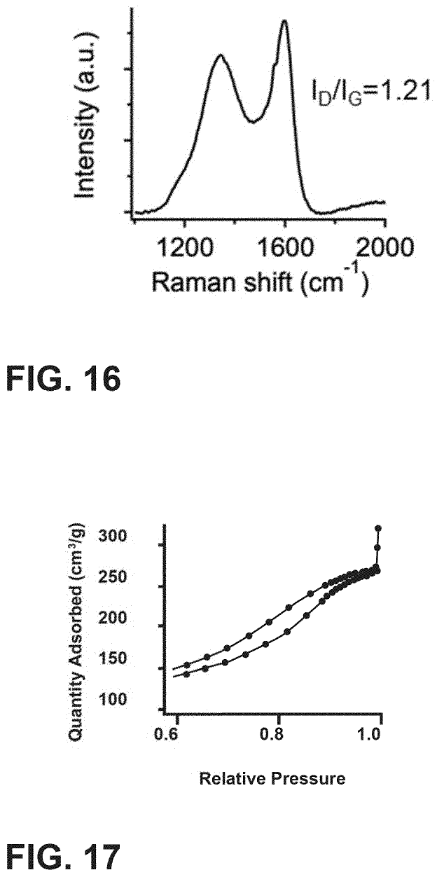

Furthermore, Raman spectroscopy was employed to characterize the degree of graphitization of the resulting carbon fibers. In general, carbon materials with higher degrees of graphitization can exhibit better electrical and thermal conductivity through facilitating the electron transport along the in-plane direction as opposed to the amorphous carbon counterparts. Results of the spectroscopy are shown in FIG. 16. As shown by the graph of FIG. 16, the ratio of the intensities of the disordered (at 1370 cm⁻¹) and graphitic bands (at 1597 cm⁻¹) was 1.21.

The N₂ adsorption-desorption behavior of the mask-derived carbon fiber was characterized using gas physisorption measurements, which can determine pore volume, pore size distribution, and surface area of the carbon samples. Specifically, pore size distribution of samples was estimated from the adsorption isotherm using the Barrett, Joyner and Halenda (BJH) model, whereas the surface area was determined from the typical Brunauer Emmett and Teller (BET) analysis.

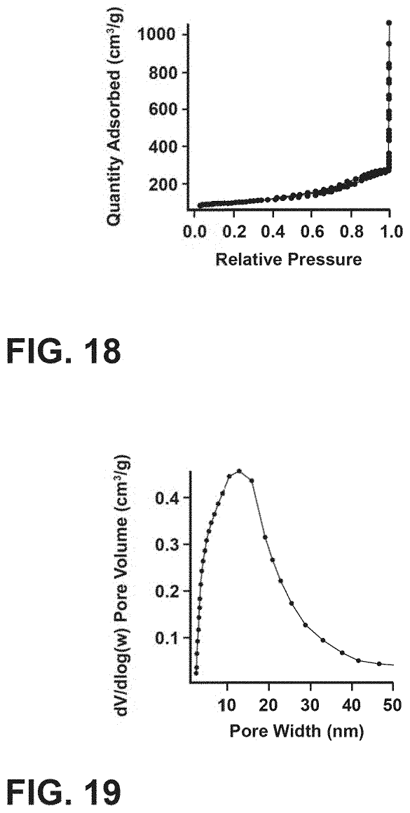

The sulfonated fibers prior to the carbonization possess no micropores. As shown in FIG. 17, the resulting carbon fibers exhibited a typical type V isotherm, suggesting the presence of both macropores and mesopores. The resulting carbon fibers further exhibited a surface area of about 295.46 m²/g. As shown in FIG. 18, hysteresis occurs at a partial pressure range from 0.6 to about 1.0. Furthermore, as shown in FIG. 19, the pore size distribution was relatively uniform and centered around about 12 nm. The generation of these pores occurred during the carbonization process when portions of the polymer chains were thermally degraded and gases (CO, CO₂, H₂O, SO₂) were evolved.

### Example 6

To further demonstrate the use of derived carbon fibers in practical applications, experiments using the samples from Example 5 were performed to determine Joule heating. The ability of a material to reach elevated temperatures upon the application of low voltages through Joule heating provides great potential in several applications, including thermotherapy, crude oil recovery, and thermochromics. Joule heating is a result of electrons colliding with atoms within a conductor, and which generates heat in regions where current transmits. Equation 1 simplistically depicts the Joule heating of a current density j in an electrical field E in a material of electrical conductivity g.

Equation 1: =

This relationship demonstrates that the thermal energy produced from Joule heating is directly dictated by the conductivity of the material where enhanced conductivity results in increased output of energy in to form of Joule heating. In Joule heating experiments, carbonized mask fibers were subjected to different voltages, then allowed to be equilibrated. Specifically, the Joule heating capabilities of the carbonized mask fibers were determined by connecting the fibers to a DC power supply using a glass slide as a support. The voltage was increased in increments of 1 V and the temperature was measured using a thermal camera (from HTI) until the equilibrium state was reached.

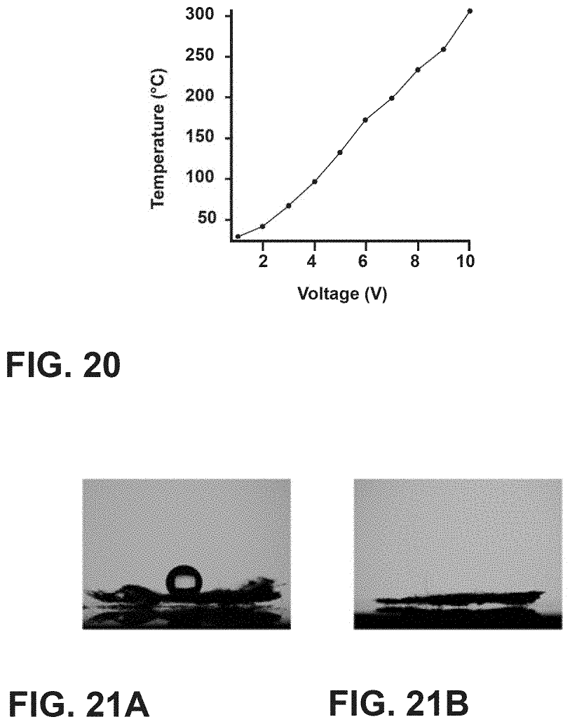

As shown in FIG. 20, with the application of increased voltage from 1 V to 10 V, the mask-derived carbon fibers can reach a broad temperature range from 29° C. to greater than 300° C. with the application of 10 V. For example, at 9 V, the temperature of the porous carbon fibers was at about 248° C. Due to the high conductivity of the carbon fibers, the heating happens rapidly and equilibrates in a matter of seconds. After the voltage is removed, heat dissipates quickly, and the porous carbon fibers return to room temperature in less than 10 seconds. These results suggest that the porous carbon fibers derived from a precursor material such as structured plastic waste could be employed as fillers in preparing Joule-heating composites. In various examples, the carbonized materials may exhibit a thermal conductivity of about 150 (W/mk).

### Example 7

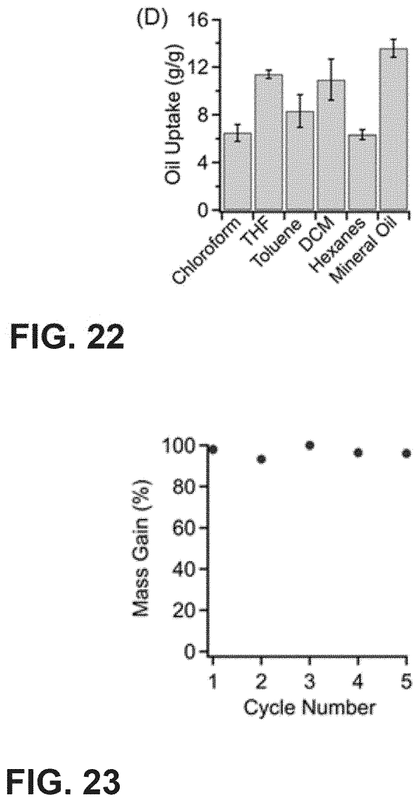

To further highlight the applications of the resulting carbon fibers from Example 5, water contact angle measurements were recorded and analyzed using a goniometer and Contact Angle software from Ossila. The carbonized mask fibers from Example 5 exhibit high water contact angles (FIG. 21A), but are easily wet by organic solvents, such as chloroform (FIG. 21B). The carbonized mask fibers were further tested for their ability to absorb organic solvents which acted as surrogates for oil-based pollutants. Acetone and chloroform were easily absorbed by simply placing the carbonized fibers into the solvent droplets. This behavior was consistent for many organic solvents, as demonstrated in FIG. 22.

Oil adsorption studies were performed by submerging carbonized mask fibers into 20 mL various organic solvents for at least 5 minutes, and recording the mass adsorbed immediately after removing from the solvent. The carbon mask fibers exhibited varied adsorption capacities for different organic solvents, with a maximum amount of up to 14 grams of mineral oil per gram of carbon fiber. The difference in the uptake capacity against different solvents is primarily associated with the surface energy of carbon surfaces and the interactions between the surface functional groups and solvent molecules.

The hydrophobicity of carbon materials enables their use for oil adsorption. The favorable interactions between organic solvents and hydrophobic carbon drives the adsorption of oils to the carbon surface. Additionally, this performance is highly cyclable, where the sorbate can be efficiently removed, and the carbon fibers can be reused in further adsorption. This advantageous property was confirmed in FIG. 23, where chloroform was been repeatedly adsorbed by a carbon fiber mat, recovered, and adsorbed again for five cycles.

### Example 8

In this Example 8, samples of Example 6 were further tested through activation of the resulting carbon fiber product. The activation process was performed by physically grinding the previously produced carbon fiber product with potassium hydroxide (KOH) at a 1:2 mass ratio. After activation at 700° C. with a ramp rate of 1° C./min for 1 h, the product was washed with DI water, centrifuged, and then dried. This process was repeated 6 times. The carbonized masks were activated through reacting with KOH to enhance the porosity of the carbon fibers and increase surface area.

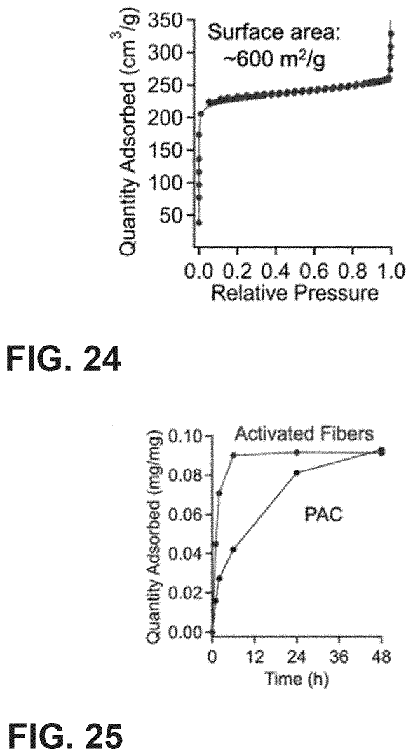

From the N₂ isotherm in FIG. 24, it is evident by the large increase in the quantity of N₂ adsorbed at low relative pressures (p/p₀: 0-0.1) that micropores have been generated in the fibers. The activation process significantly improves the surface area of these carbon fibers from 295 m²/g to 600 m²/g. After activation the fibral structures of these materials were well retained. It was also found that the oxygen content of carbon fibers increases from 0 wt % to 25.6 wt %, determined by the EDX measurements.

To gauge the performance of the activated mask in water remediation applications, dye adsorption studies were performed with a water-soluble dye, basic blue 17. The adsorption capacities as a function of time in 3 different dye concentrations were investigated, which were 0.07 mg/mL, 0.15 mg/mL, and 0.30 mg/mL. The activated mask fibers had adsorption capacities of roughly 0.033 mg/mg, 0.09 mg/mg, and 0.19 mg/mg for the 0.07 mg/mL, 0.15 mg/mL, and 0.30 mg/mL solutions, respectively. Results for the 0.15 mg/mL solution are shown in FIG. 25.

The dye adsorption kinetics were fit to a pseudo first order model using Equation 2 where q [symbol] is the amount of dye adsorbed at equilibrium, q [symbol] is the amount of dye adsorbed at time t, and k₁ is the first order equilibrium rate constant

$$log ( q \text{?} - q \text{?} ) - log q \text{?} - \frac{{k}_{1}}{2.303} t \qquad Equation 2$$

$$\text{?} \text{indicates text missing or illegible when filed}$$

At 0.15 mg/mL and 0.30 mg/mL, the rate constant of the dye adsorption by the activated fibers (0.649 h⁻¹ and 0.213 h⁻¹, respectively) was significantly higher than the adsorption by the standard commercially available PAC (0.076 h⁻¹ and 0.075 h⁻¹, respectively).

### Example 9

In this Example 9, the initial structure selected was PP-based surgical masks. During the step of preparing the initial structure step, the surgical masks were cut to remove the elastic bands and metal nosepiece. The resulting fabric was separated into three constituent layers, including two layers of non-woven fabrics and a melt-spun mat layer. In this Example 10, only outer layers were used to samples of the initial structure with each sample weighing about 0.3 grams.

To sulfonate the samples of the initial structure, the samples were transferred into glass containers containing about 30 ml of concentrated sulfuric acid (98 wt %). In this step, a glass slide was placed on top of the mask-formed initial structures to keep the initial structures completely submerged in the sulfuric acid throughout the reactions. The glass containers were then placed in a muffle furnace and heated to about 145° C.

Upon sulfonation, the samples of the initial structure were removed from the muffle furnace and cooled down to room temperature. To wash the samples, sulfuric acid was first removed from the glass containers. Subsequently, the samples were washed at least three times with deionized water in order to completely remove the residue acid. The samples were then placed in a vacuum oven overnight to dry to ensure any residual water was removed.

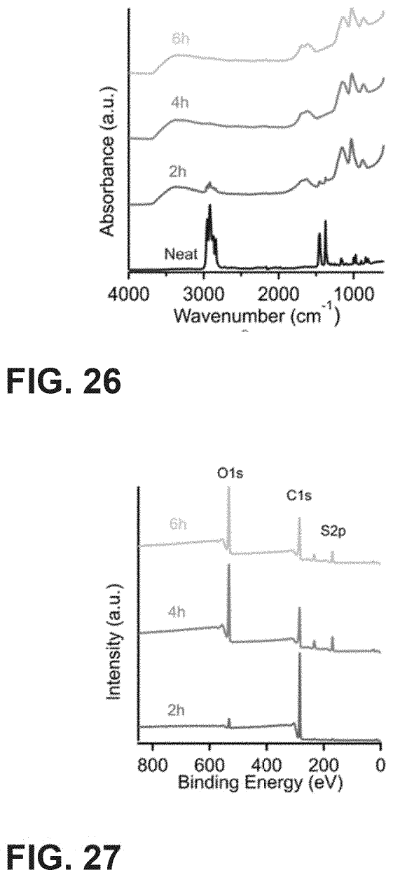

A PerkinElmer Frontier Attenuated Total Reflection (ATR) Fourier-transform infrared (FTIR) spectrometer was used to record the changes in chemical compositions of the sulfonated samples as a function of time. The scan range was 4000 cm¹−600 cm⁻¹ with 32 scans and a resolution of 4 cm′. The progress of the sulfonation reaction was monitored through FTIR spectroscopy. Results of this monitoring are illustrated in FIG. 26.

As shown in FIG. 26, FTIR spectra confirmed that sulfonation reaction results in the formation of double bonds and sulfonic acid groups in PP. Specifically, neat PP fibers from masks exhibited peaks indicative of C—H stretching at about 2920 cm⁻¹ which diminished as the sulfonation/crosslinking reaction progressed and completely disappeared after about 4 hours of reaction time. The intensity of these peaks first reduced after about 2 hours, indicating an incomplete crosslinking of PP fibers. After about 4 hours, these peaks completely disappeared. The peak at 3326 cm⁻¹ corresponds to the hydroxyl groups of the sulfonic acid moieties introduced to the polymer backbone and is further evidence of the sulfonation reaction. Additionally, the formation of alkenes is represented by the peak at 1604 cm⁻¹ and the formation of sulfonic acid groups is evidenced by the peaks from 1150-1000 cm⁻¹. It was found that after about 4 hours, the FTIR spectra remain nearly constant which suggests that the reaction is complete.

In addition to FTIR spectroscopy, the change in the chemical composition of crosslinked PP fibers as a function of reaction time was investigated through XPS. FIG. 27 illustrates survey scans of the crosslinked fibers with increasing sulfonation time. After about 2 hours of reaction time, low degree of sulfonation occurs with limited increase in levels of oxygen and sulfur to about 3.3 atom % (at about 532.23 eV) and about 0.6 atom % (at about 169.3 eV), respectively. Increasing reaction time to about 4 hours resulted in significantly more pronounced peaks corresponding to these two heteroatoms. After about 4 hours of sulfonation, the oxygen and sulfur content reached plateau values at about 42.2% and about 9.7%, respectively. Moreover, the oxygen to sulfur ratio of approximately 4 indicates that an additional oxygen containing functionality is incorporated into the polymer for every sulfonic acid group that is attached to the backbone. This is likely due to side reactions which can form ketone species or other functional groups.

### Example 10

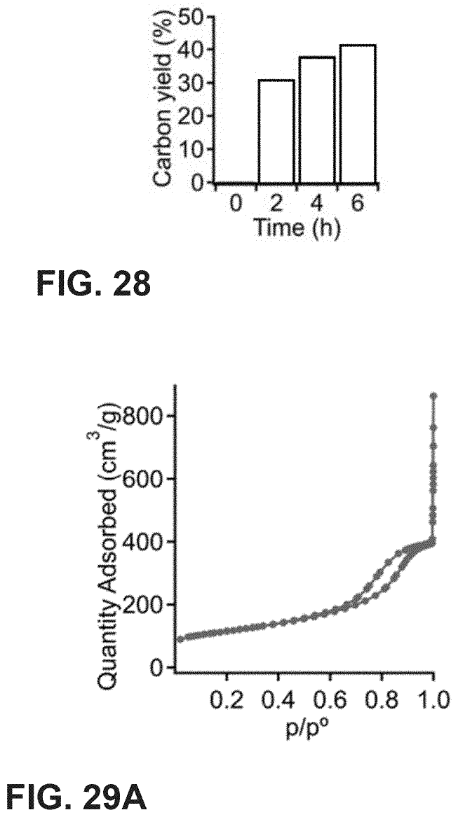

In this Example 10, after the sulfonation crosslinking reaction, the samples of Example 9 were washed and subsequently carbonized under N₂ atmosphere at about 800° C. The crosslinking reaction enabled carbon yields up to about 45% as shown in FIG. 28. Specifically, about 2 hours of sulfonation results in reduced carbon yield of about 30%. Shorter reaction times resulted in incomplete crosslinking of PP fibers, and the underreacted fiber in the core regions were susceptible to thermal degradation. After about 4 hours of sulfonation, the carbon yield reached a plateau at about 40%, confirming that about 4 hours of crosslinking using concentrated sulfuric acid at about 145° C. is sufficient to fully crosslink the PP fibers in the samples. While this temperature is lower than the melting temperature of PPs, attached sulfonic acid groups on polymer backbones makes PP becomes significantly more hydrophilic, which allows the efficient penetration of acid for further crosslinking.

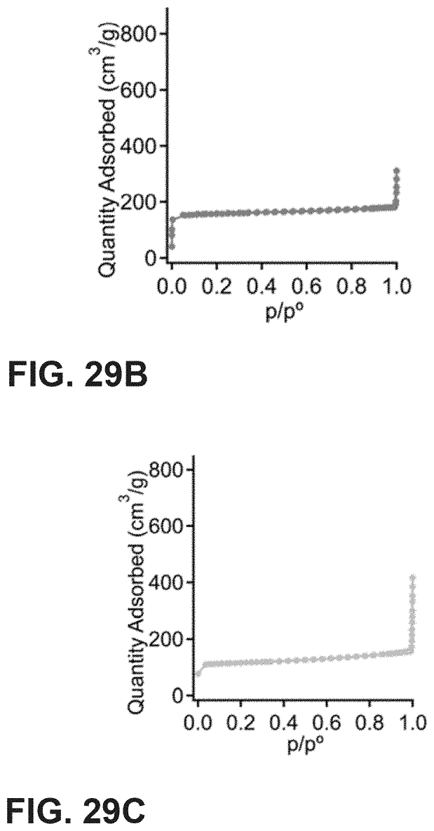

Nitrogen sorption isotherms at 77 K were used to determine the pore characteristics of the carbonized fibers as a function of sulfonation time and are depicted in FIG. 29A-29C. After about 2 hours of sulfonation (FIG. 29A), lower degrees of sulfonation resulted in the formation of larger mesopores from un-crosslinked PP, which are susceptible to thermal degradation. At longer sulfonation times, only micropores are present as a result of higher degrees of crosslinking (see FIGS. 29B and 29C). The carbonized PP fibers exhibited surface areas of about 389 m²/g for samples with about 2 hours of reaction time, about 486 m²/g for samples with about 4 hours of reaction time, and about 361 m²/g for samples with about 6 hours of reaction time.

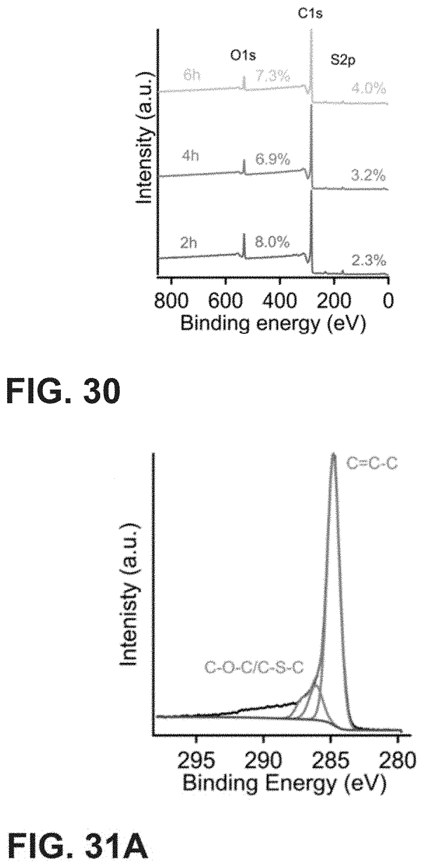

After carbonization, the heteroatom content of the carbon fibers was determined through XPS. FIG. 30 illustrates survey scans of the fibers which were carbonized after varying sulfonation times, and the corresponding heteroatom content of C, O, and S. Generally, the carbonization process resulted in the degradation of most heteroatom-containing functional groups while forming carbon frameworks. With increased reaction time, it was found that the sulfur content in the material increases while the oxygen content decreases. Carbon fibers that were initially sulfonated for about 2 hours exhibited heteroatom contents of about 8 atom % and about 2.3 atom % for oxygen and sulfur, respectively. Increasing reaction time to about 6 hours reduces the oxygen content to about 7.3 atom % and very slightly increases the amount of sulfur to about 4.0 atom %. The presence of heteroatoms is anticipated to strengthen the capability of mask-derived carbon fibers for capture CO₂ as previously discussed.

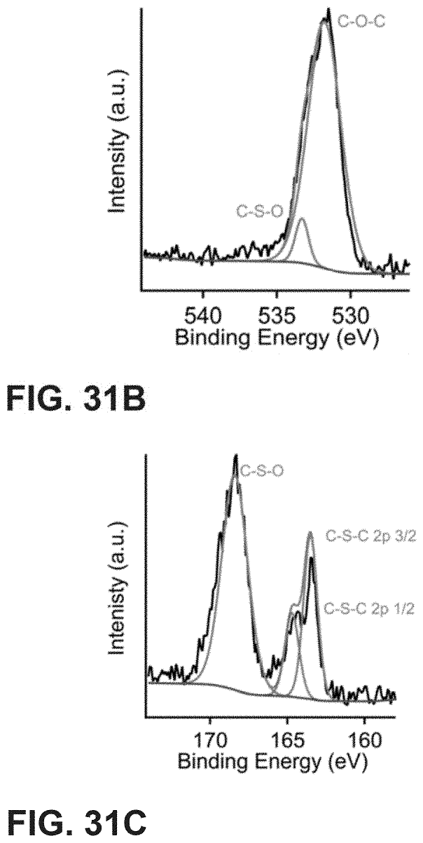

The heteroatom content of the materials is further elucidated in the high resolution XPS scans in FIG. 31 Representative carbon, oxygen, and sulfur high resolution scans are found in FIGS. 31A-31C, respectively. The most predominant bond is the C═C—C found in FIG. 31A, which corresponds to the conjugated framework of the carbonized fiber. Within the carbonized fiber, the most prevalent oxygen containing functionality are represented by the C—O—C peak at about 532.1 eV which represents epoxide groups. From the high-resolution sulfur scan, it is shown that most of the S atoms are represented by the peak at about 168.4 eV, which corresponds to C—S—O bonds. Previously, oxidized sulfur containing functional groups have been demonstrated to enhance the CO₂ adsorption performance of porous carbons due to favorable interactions between the basic groups and the polar gas molecule. As set forth in Table 3 below, the fibers that were crosslinked for about 6 hours, depicted the highest population of the C—S—O functional group when considering their elevated content.

TABLE 3

| Carbon | | | | | | Sulfur | | |
|---|---|---|---|---|---|---|---|---|
| Crosslinking | | C—O—C/ | Oxygen | | | | C—S—C | C—S—C |
| Time | C═C—C | C—S—C | C—O—C | C—S—O | C—S—O | C—S—C | 2p 3/2 | 2p 1/2 |
| 2 hours | 88.6% | 11.4% | 92.2% | 7.8% | 86.6% | 13.4% | — | — |
| 4 hours | 86.1% | 13.9% | 93.6% | 6.4% | 71.1% | — | 19.8% | 9.1% |
| 6 hours | 89.2% | 10.8% | 85.0% | 15.0% | 68.4% | — | 16.4% | 15.2% |

### Example 11

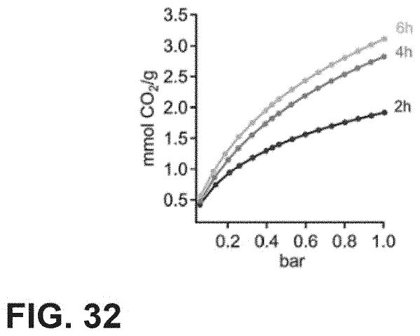

In this Example 11, carbonized samples from Example 10 were tested using a Micromeritics Tristar II instrument to determine CO₂ and N₂ sorption performance at ambient temperature. Due to the largely similar pore characteristics of the samples of Example 10, the effect of the increased presence of sulfur groups can be observed in the CO₂ adsorption isotherms in FIG. 32. The porous nature and heteroatom content of the fibers enable their use as sorbents for CO₂ capture. Notably, the maximum specific sorption capacity exhibited by the carbon fibers is 3.33 mmol/g at 1 bar.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A structure comprising:
one or more carbonized materials, wherein each carbonized material has been crosslinked, wherein each carbonized material has a shape based on a polymer based template structure.

2. The structure of claim 1, wherein the carbonized materials are formed of a cross-linked resol coating.

3. The structure of claim 2, wherein each carbonized material has a pore structure comprising an average surface area of about 2500 m²/g to about 2700 m²/g and an average pore volume of about 40 cm³/g to about 45 cm³/g.

4. The structure of claim 2, wherein each carbonized material has a pore structure comprising an average surface area of about 500 m²/g to about 2500 m²/g and an average pore volume about 5 cm³/g to about 45 cm³/g.

5. The structure of claim 1, wherein the carbonized materials are formed of a cross-linked polyolefin based structure having a chemical structure:

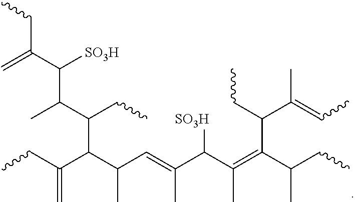

6. The structure of claim 5, wherein each carbonized material has a pore structure comprising an average surface area of about 250 m²/g to 700 m²/g and an average pore volume of less than about 1 cm³/g.

7. The structure of claim 5, wherein the carbonized material is formed of a sulfonated polyolefin.

8. The structure of claim 1, wherein the template structure is formed of a template material having a polyeolefin backbone.

9. The structure of claim 1, wherein the carbonized materials retain a shape and structure of the template material.

10. The structure of claim 1, wherein the template structure is one of a 3D printed structure, a fiber, a porous scaffold, an injection molded structure, an extruded structure, or a compression molded structure.

11. A structure comprising:
one or more carbonized materials each formed of a chemical compound having the structure: 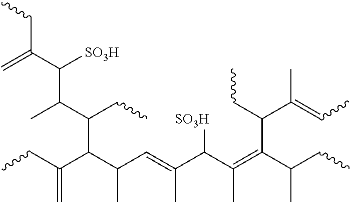
wherein each carbonized material has a pore structure comprising an average surface area greater than about 200 m²/g and an average pore volume of less than about 1 cm³/g.

12. The structure of claim 11, wherein the carbonized materials are doped with sulfur.

13. The structure of claim 11, wherein the carbonized materials are formed from and retain a shape of a template structure including a plurality of fibers.

14. The structure of claim 11, wherein the carbonized materials are activated carbonized materials, and further wherein the activated carbonized materials have a surface area of greater than about 600 m²/g.

15. The structure of claim 11, wherein the carbonized materials exhibit a thermal conductivity of about 150 (W/mk).

16. The structure of claim 11, wherein the carbonized materials exhibit a CO₂ sorption capacity of about 3.3 mmol/g at 25° C.
